(19) United States
(12) Patent Application Publication
(10) Pub. No.: US 2012/0049516 A1
(43) Pub. Date: Mar. 1, 2012

(54) METHOD, SYSTEM, AND COMPUTER PROGRAM PRODUCT TO OPTIMIZE POWER PLANT OUTPUT AND OPERATION

(75) Inventor: Daniel Viassolo, Katy, TX (US)

(73) Assignee: VESTAS WIND SYSTEMS A/S, Randers SV (DK)

(21) Appl. No.: 12/868,459

(22) Filed: Aug. 25, 2010

(51) Int. Cl. H02P 9/04

(52) U.S. Cl. 290/44

(57) ABSTRACT

Method, power plant, and computer program product for use in optimizing power plant power and operation. The power plant includes a wind farm, an energy storage system, and a supervisory controller implementing a control algorithm that receives information on the wind farm and on the energy storage and, based on that information, computes a power reference for the wind farm and a power reference for the energy storage. These power references optimize a given power plant objective subject to a given set of constraints on the power plant.

### BACKGROUND

This application relates generally to electrical power generation and, more specifically, to methods, systems, and computer program products for use in optimizing the power output produced by a power plant that includes a wind farm and an energy storage device.

A wind farm, or wind park, includes a group of wind turbines that operate collectively as a power plant that generates a power output to a power grid. Wind turbines can be used to produce electrical energy without the necessity of fossil fuels. Generally, a wind turbine is a rotating machine that converts the kinetic energy of the wind into mechanical energy and the mechanical energy subsequently into electrical power. Conventional horizontal-axis wind turbines include a tower, a nacelle located at the apex of the tower, and a rotor that is supported in the nacelle by a shaft. A generator, which is housed inside the nacelle, is coupled by the shaft with the rotor. Wind currents activate the rotor, which transfers torque to the generator. The generator produces electrical power that is eventually output to the power grid.

Due to the natural intermittency of wind, the power output from a particular wind turbine or wind farm is less consistent than the power output from conventional fossil fuel-fired power plants. As a result, the power from wind turbines operating at nominal conditions in a wind farm may not meet output requirements. For example, the power from the wind power plant often will not track the forecasted power due to wind forecast errors. As another example, the rate of change of power for a wind power plant may be outside of a desired range because of wind gusts. A conventional approach for dealing with these and other similar situations is to use wind turbine controls to manage the operation of the wind farm, such as utilizing pitch control of the rotor blades to increase or decrease, within some limits, the power produced by the individual wind turbines.

A wind farm could also include an energy storage device, such as one or more rechargeable batteries or flywheels, that are also linked to the power grid and that may assist with meeting requirements on the power production by the power plant. When energy demand peaks, the wind turbines of the wind farm will sink energy directly into the power grid. When energy demand is diminished, excess energy from the wind turbines may be stored in the energy storage device and later discharged to the power grid upon demand to alleviate any deficits in output requirements for the power plant.

The conventional approach is to decide the control actions for the wind turbines independently of the energy storage operating conditions. That is, conventional wind farm and wind turbine controls are designed to capture as much energy as possible from the wind as long as the stresses on turbine components are acceptable, regardless of the energy storage conditions; e.g., state of charge, remaining life time, etc. Under this conventional approach, the presence of the energy storage device does not have any direct impact on the control decisions for the wind turbines. Charging or discharging of the energy storage device is implemented only after the control actions for the wind turbines are decided.

Under the conventional approach, operational control is not necessarily optimized from the overall perspective of the power plant; that is, from the perspective of the wind farm and the energy storage as a system. For example, the lack of coordinated control actions can lead to un-necessary consumption of the lifetime of the energy storage device and/or the lifetime of the wind turbines. As another example, the energy storage device may be operated outside the range of preferred operating parameters (currents, voltages, temperatures, etc.) leading to very low efficiencies. As yet another example, the lack of coordinated control actions may yield wind turbine operation at unnecessarily large actuator rates of change to, for example, the rotor pitch. As yet another example, when a wind gust hits the turbine, the energy storage device can be used to absorb or release power and thus reduce the power oscillations that would be otherwise passed to the power grid. By operating the wind turbines without directly acknowledging the conditions of the energy storage device, system-level objectives are in general not optimized.

Improved methods, systems, and computer program products are needed for coordinating the use of energy storage devices and wind turbines in a wind farm.

### BRIEF SUMMARY

Generally, the control algorithms of the embodiments of the invention receive information on the status of both the wind farm and the energy storage, and compute the power references that optimize a given power plant objective subject to a given set of constraints imposed on the power plant.

In an embodiment of the invention, a power plant is provided for outputting power to a point of common connection with a power grid. The power plant includes a wind farm with a plurality of wind turbines configured to generate and output a first portion of the power to the point of common connection. The power plant also includes an energy storage system with an energy storage device configured to output a second portion of the power to the point of common connection. The energy storage device is configured to be charged by the wind turbines. A supervisory controller is coupled in communication with the energy storage system and in communication with the wind farm. The supervisory controller is configured to implement a control algorithm to dynamically compute a first power reference for the first portion of the power output by the wind farm and a second power reference for the second portion of the power output by the energy storage system.

In another embodiment of the invention, a computer-implemented method is provided for controlling power output by a power plant to point of common connection with a power grid. A control algorithm dynamically computes a first power reference for a first portion of the power output from a wind farm of the power plant and a second power reference for a second portion of the power output by an energy storage system of the power plant. The energy storage system is controlled to output the first portion of the power to the point of common connection based upon the first power reference. The wind farm is controlled to output the second portion of the power to the point of common connection based upon the second power reference.

The method may be implemented as a computer program product in which instructions for performing the method are stored on a computer readable storage medium.

### BRIEF DESCRIPTION OF THE SEVERAL VIEWS OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention.

FIG. 1 is a perspective view of a wind turbine.

FIG. 2 is a perspective view of a portion of the wind turbine of FIG. 1 in which the nacelle is partially broken away to expose structures housed inside the nacelle.

FIG. 3 is a diagrammatic view of power plant that includes a wind farm with multiple wind turbines like the wind turbine of FIGS. 1 and 2, an energy storage device, and a power plant controller in accordance with an embodiment of the invention.

FIG. 4 is another diagrammatic view of the power plant of FIG. 3.

FIG. 5 is a flow chart showing the control and optimization of power plant output and operation in accordance with an embodiment of the invention.

### DETAILED DESCRIPTION

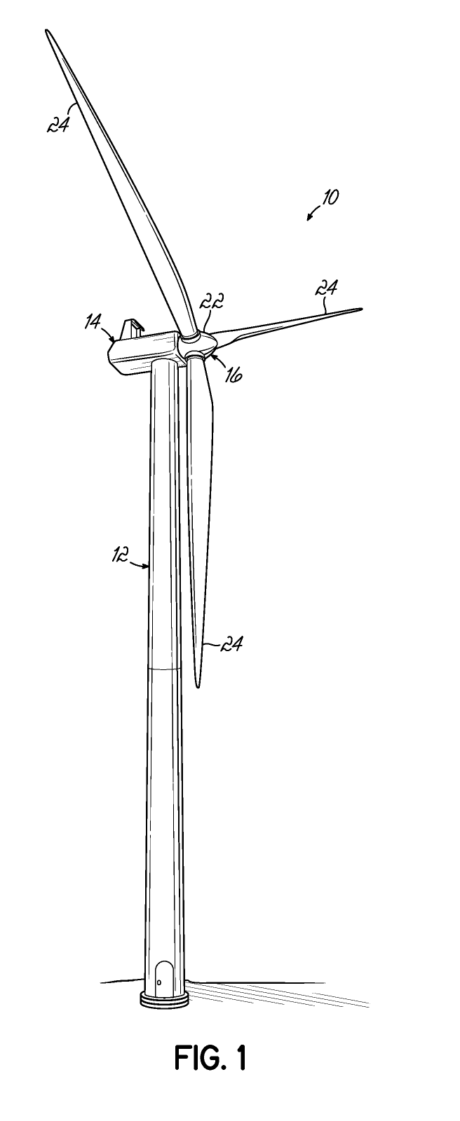

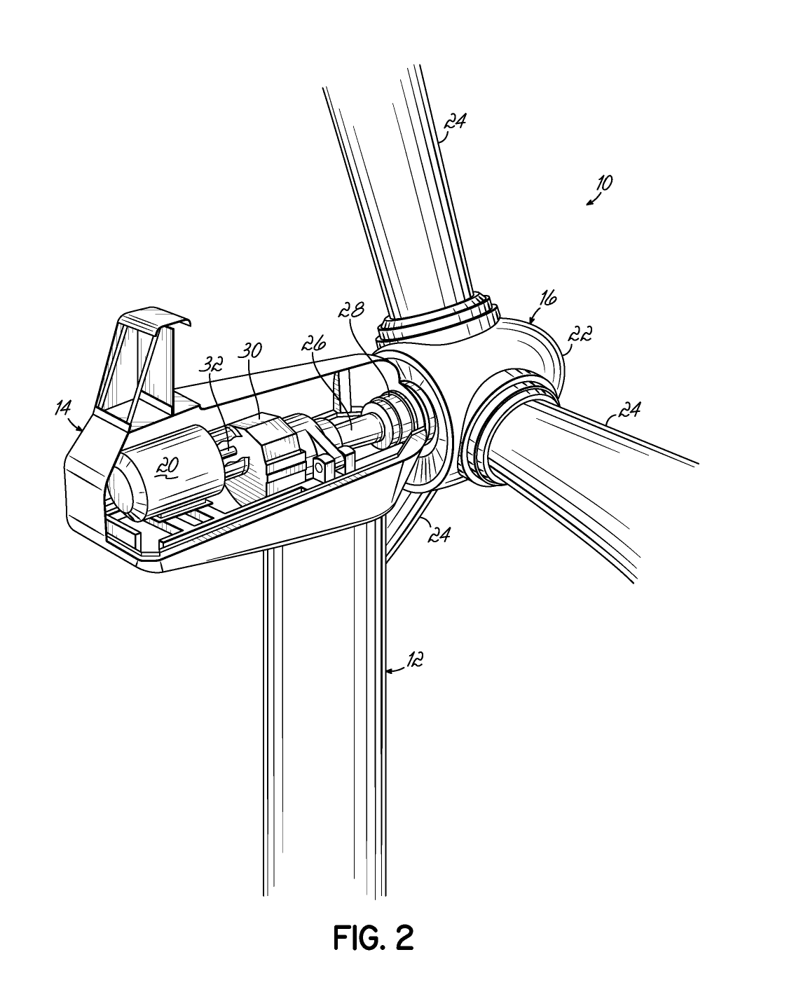

With reference to FIGS. 1 and 2 and in accordance with an embodiment of the invention, a wind turbine 10, which is depicted as a horizontal-axis machine, includes a tower 12, a nacelle 14 disposed at the apex of the tower 12, and a rotor 16 operatively coupled to a generator 20 housed inside the nacelle 14. In addition to the generator 20, the nacelle 14 houses miscellaneous components required for converting wind energy into electrical energy and various components needed to operate, control, and optimize the performance of the wind turbine 10. The tower 12 supports the load presented by the nacelle 14, the rotor 16, and other components of the wind turbine 10 that are housed inside the nacelle 14 on an underlying foundation. The tower 12 of the wind turbine 10 also operates to elevate the nacelle 14 and rotor 16 to a height above ground level or sea level, as may be the case, at which faster moving air currents of lower turbulence are typically found.

The rotor 16 includes a central hub 22 and a plurality of blades 24 attached to the central hub 22 at locations circumferentially distributed about the central hub 22. In the representative embodiment, the rotor 16 includes a plurality of three blades 24 but the number may vary. The blades 24, which project radially outward from the central hub 22, are configured to interact with the passing air currents to produce aerodynamic lift that causes the central hub 22 to spin about its longitudinal axis. The design, construction, and operation of the blades 24 are familiar to a person having ordinary skill in the art. For example, each of the blades 24 is connected to the central hub 22 through a pitch mechanism that allows the blade to pitch under control of a pitch controller. The nacelle 14 and rotor 16 are coupled by a bearing with the tower 12 and a motorized yaw system (not shown) is used to maintain the rotor 16 aligned with the wind direction.

A low-speed drive shaft 26 is mechanically coupled at one end with the central hub 22 of the rotor 16 and extends into the nacelle 14. The low-speed drive shaft 26 is rotatably supported by a main bearing assembly 28 coupled to the framework of the nacelle 14. The low-speed drive shaft 26 is coupled to a gear box 30 having as an input the low-speed drive shaft 26, and having as an output a high-speed drive shaft 32 that is operatively coupled to the generator 20. The generator 20 may be any type of synchronous generator or asynchronous generator as recognized by a person having ordinary skill in the art and is generally understood to be a rotating electrical machine that converts mechanical energy into electrical energy by creating relative motion between a magnetic field and a conductor.

Wind exceeding a minimum level activates the rotor 16 and causes the blades 24 to rotate in a plane substantially perpendicular to the wind direction. The positive torque transferred from the rotor 16 to the generator 20 causes the generator 20 to convert the mechanical energy into AC electrical power so that the kinetic energy of the wind is harnessed for power generation by the wind turbine 10. The wind turbine 10 is characterized by a power curve describing the output power generated as a function of wind speed and the wind turbine 10 is operated with recognition of cut-in, rated, and cut-out wind speeds.

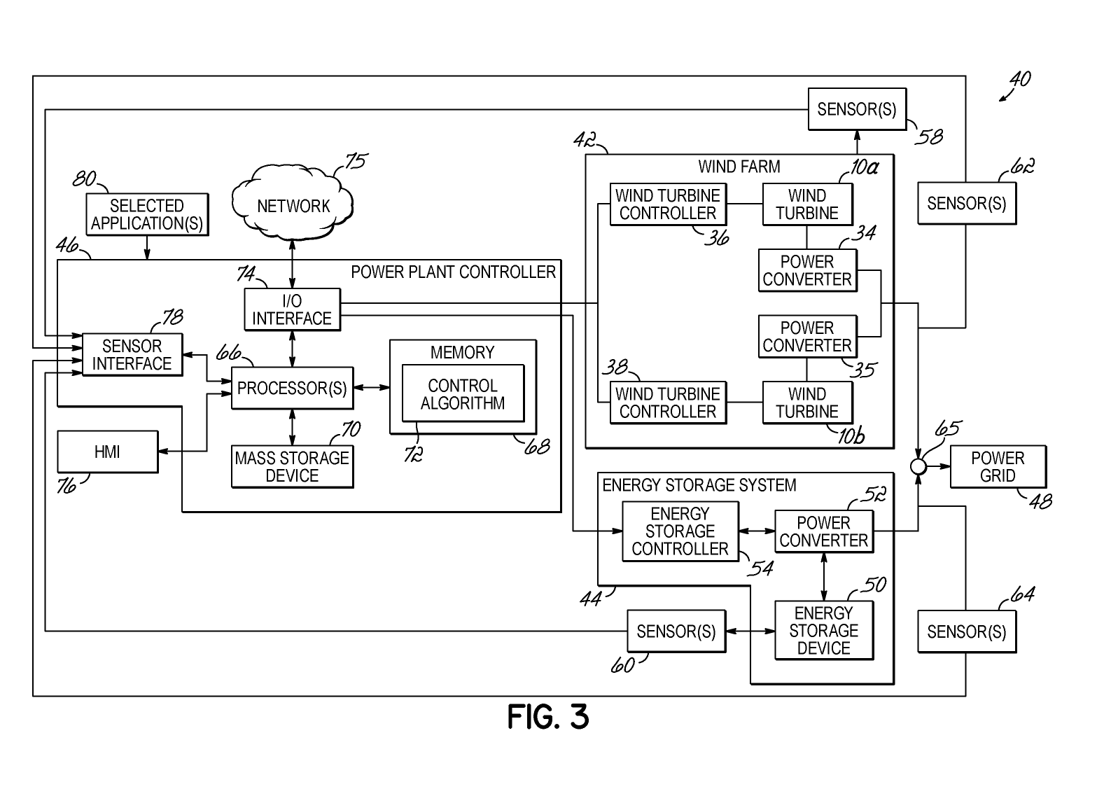

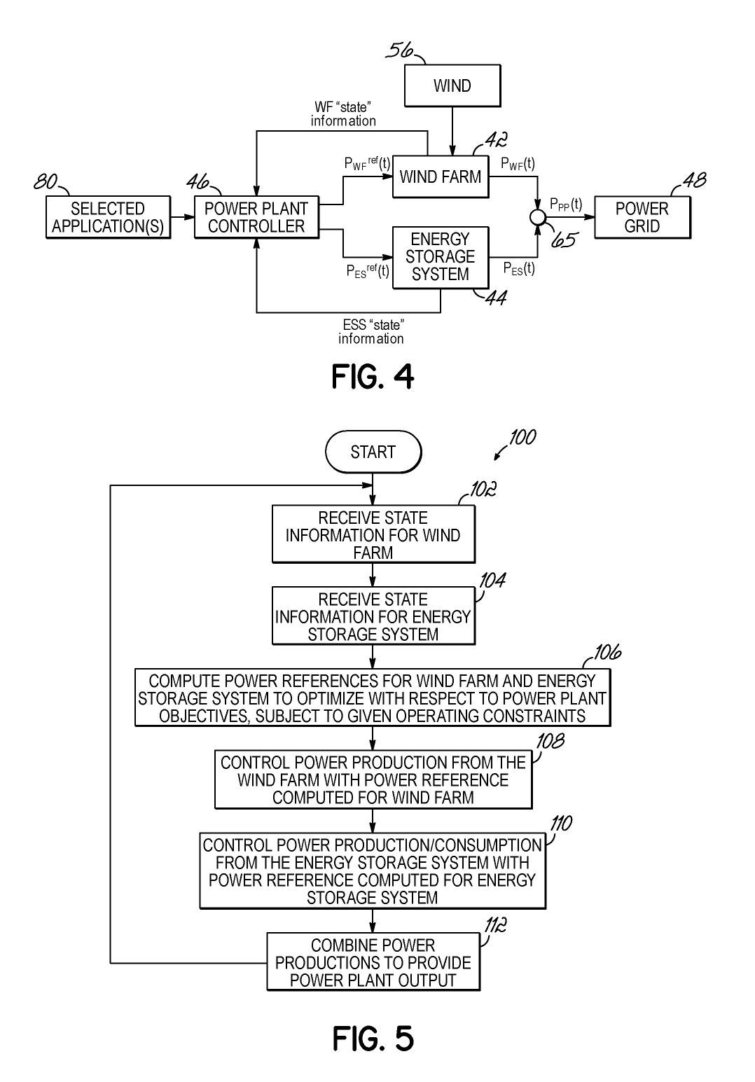

With reference to FIGS. 3 and 4, a power plant 40 includes a wind park or wind farm 42 containing a group of wind turbines 10a, 10b sited at a common physical location and an energy storage system 44, as well as a power plant controller 46 that provides supervisory control over the power plant 40. The power plant 40 is electrically coupled with a power grid 48, which may be a three-phase power grid. The wind turbines 10a, 10b each have a construction similar or identical to the construction of the representative wind turbine 10. The wind farm 42 may contain additional wind turbines (not shown) like the representative wind turbines 10a, 10b such that the total number of wind turbines in the wind farm 42 is arbitrary within reason. In various embodiments, the wind farm 42 may include from ten (10) to one hundred (100) wind turbines distributed over tens of square kilometers of land area.

A power converter 34, 35 is configured to receive the AC voltage generated by the generator 20 of each of the wind turbines 10a, 10b and to supply an AC voltage to the power grid 48. Each of the wind turbines 10a, 10b includes wind turbine controller 36, 38 that manages the operation of the wind turbine components and subsystems by implementing, for example, pitch controls, yaw controls, generator controls, etc. In one aspect of turbine management, each of the wind turbine controllers 36, 38 is coupled in communication with a respective one of the power converters 34, 35 and generates controls signals for power output that are supplied to the power converter 34, 35. In response to the control signals, each power converter 34, 35 rectifies the AC voltage from the generator 20 of the wind turbine 10a, 10b to obtain a filtered DC voltage and then converts the DC voltage to an AC voltage at a desired constant frequency (e.g., 50 Hz or 60 Hz) that is output as three-phase alternating current (AC) to the power grid 48. The wind turbine controllers 36, 38 may control the functions of other sub-controllers that locally control parts of each wind turbine 10a, 10b, such as pitch control over the blades 24 of the rotor 16.

The energy storage system 44 includes an energy storage device 50, a power converter 52, and an energy storage controller 54 that manages the operation of the power converter 52. The energy storage device 50 is coupled with the power grid 48 and is in parallel arrangement with the generators 20 of the wind turbines 10a, 10b in wind farm 42. The energy storage controller 54 is coupled in communication with the power converter 52 and generates controls signals that are supplied as commands to the power converter 52.

In the representative embodiment, the energy storage device 50 includes one or more rechargeable batteries. Exemplary batteries based upon electro-chemical storage batteries include, but are not limited to, lead-acid, lithium ion, and vanadium redox batteries. In alternative embodiments, the energy storage device 50 may be a different type of device, such as a flywheel or a bank of capacitors, capable of receiving and stably storing electrical energy, and also capable of discharging the stored electrical energy under the control of the power plant controller 46. In another alternative embodiment, the energy storage device 50 may be hybrid in the sense that energy storage device 50 may include devices of different types, such as one or more flywheels, one or more banks of capacitors, one or more rechargeable batteries, or combinations of these devices.

The energy storage controller 54, in conjunction with the wind turbine controllers 36, 38, controls the ability of the energy storage device 50 to receive and store energy from the wind turbines 10a, 10b in wind farm 42. Excess energy produced by the wind turbines 10a, 10b may be stored in the energy storage device 50. In response to control signals from the respective wind turbine controllers 36, 38, the power converters 34, 35 are configured to divert electrical energy produced by the generators 20 of the wind turbines 10, 10b to the power converter 52 of the energy storage device 50. The power converter 52 is configured to adjust the voltage level of the DC voltage for compatibility with the energy storage device 50 and route the DC voltage to the energy storage device 50, which stores the electrical energy contained in the DC voltage.

At the direction of control signals received from the energy storage controller 54, the power converter 52 may be directed to discharge stored energy in a controlled manner as DC voltage from the energy storage device 50 to the power converter 52. The power converter 52, which is similar to power converters 34, 35, is configured to receive the DC voltage output from the energy storage device 50, filter the DC voltage, and then convert the filtered DC voltage to an AC voltage at the appropriate constant frequency. The AC voltage is then output from the energy storage system 44 as three-phase AC power to the power grid 48.

The power plant controller 46 is connected in communication with the wind turbine controllers 36, 38 in the wind farm 42. Wind 56 interacts with the wind turbines 10a, 10b, as explained above, to generate electrical power from the torque supplied from the rotor 16 to the generator 20. Control signals from the power plant controller 46 are used by each of the wind turbine controllers 36, 38 to dynamically vary the output of the respective of the wind turbines 10a, 10b in wind farm 42 to meet certain output requirements on the generated electrical power. In response to a control signal received from the power plant controller 46, each of the wind turbine controllers 36, 38 can, for example, control the yaw of the nacelle 14 and rotor 16, and control the pitch of the blades 24 to limit the rotational speed of the respective wind turbine 10a, 10b.

The power plant controller 46 is connected in communication with the energy storage controller 54 serving the energy storage system 44. Control signals from the power plant controller 46 are used by the energy storage controller 54 to regulate the operation of the energy storage device 50 and the power converter 52. In particular, the control signals from the power plant controller 46 are used to regulate the discharge of energy from the energy storage device 50 of the energy storage system 44 and the charging of the energy storage device 50.

The power plant controller 46 is configured to control an amount of electrical power output from the power plant 40 to the power grid 48. The power output from the power plant 40 typically includes a contribution from each of the wind turbines 10 in the wind farm 42 and a contribution from the energy storage system 44, although the energy storage system 44 may consume power when charging. At a substation, a transformer increases the voltage of the electrical current arriving from the wind farm 42 for connection over the high-voltage transmission lines with the power grid 48.

At least one sensor 58 measures time-varying data from the wind turbines 10 in the wind farm 42 to provide time-varying status or state information for variables relating to the operation of each of the wind turbines 10a, 10b. The at least one sensor 58 can monitor various measurable parameters and may include wind sensors, sensors for the mechanical operation of the wind turbines 10a, 10b, voltage sensors, current sensors, and/or any other sensor detecting data relevant for the functioning of the wind turbines 10a, 10b or data from the environment of the wind turbines 10a, 10b. The state information from the least one sensor 58 is communicated to the power plant controller 46 and is correlated at the power plant controller 46 with the state of the wind farm 42.

At least one sensor 60 measures time-varying data from the energy storage system 44 to generate time-varying status or state information for variables relating to the operation of the energy storage device 50. The at least one sensor 60 can monitor various measurable parameters of the energy storage device 50 and may include voltage sensors, current sensors, and/or any other sensor detecting data relevant for the functioning of the energy storage device 50 and power converter 52. The state information from the least one sensor 60 is communicated to the power plant controller 46 and is correlated at the power plant controller 46 with the state of the energy storage system 44.

At least one sensor 62 measures data for variables relating to the actual time-varying power, P_{WF}(t), output from the wind farm 42 to a point of common connection 65. At least one sensor 64 measures data for variables relating to the actual time-varying power, P_{ES}(t), output from the energy storage system 44 to the point of common connection 65. The actual time-varying power, P_{PP}(t), output from the power plant 40 during periods of power production includes contributions from both time-varying power, P_{WF}(t), and time-varying power, P_{ES}(t). The time-varying powers P_{WF}(t), P_{ES}(t) may include reactive and active components. The sensors 62, 64 can include voltage sensors for measuring voltage as a variable, current sensors for measuring current as a variable, and/or any other sensor detecting data for variables relevant to power detection and measurement. The data from the sensors 62, 64 can be communicated to the power plant controller 46 and continuously updated for computation of the time-varying powers P_{WF}(t), P_{ES}(t) at different instants in time to implementing the real-time control schemes of the embodiments of the invention.

The power plant controller 46 is a supervisory control system that can be implemented using at least one processor 66 selected from microprocessors, micro-controllers, microcomputers, digital signal processors, central processing units, field programmable gate arrays, programmable logic devices, state machines, logic circuits, analog circuits, digital circuits, and/or any other devices that manipulate signals (analog and/or digital) based on operational instructions that are stored in a memory 68. The memory 68 may be a single memory device or a plurality of memory devices including but not limited to random access memory (RAM), volatile memory, non-volatile memory, static random access memory (SRAM), dynamic random access memory (DRAM), flash memory, cache memory, and/or any other device capable of storing digital information. The power plant controller 46 includes a mass storage device 70 may include one or more hard disk drives, floppy or other removable disk drives, direct access storage devices (DASD), optical drives (e.g., a CD drive, a DVD drive, etc.), and/or tape drives, among others.

The processor 66 of the power plant controller 46 operate under the control of an operating system, and executes or otherwise relies upon computer program code embodied in various computer software applications, components, programs, objects, modules, data structures, etc. The computer program code residing in memory 68 and stored in the mass storage device 70 also includes a control algorithm 72 that, when executing on the processor 66, controls and manages the power output from the wind farm 42 by using numerical calculations to coordinate the power output from the wind farm 42 and the power output from the energy storage system 44. The computer program code typically comprises one or more instructions that are resident at various times in memory 68, and that, when read and executed by the processor 66, causes the power plant controller 46 to perform the steps necessary to execute steps or elements embodying the various embodiments and aspects of the invention.

Various program code described herein may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

For purposes of energy management and regulatory controls, the power plant controller 46 can be configured with an input/output (I/O) interface 74 to receive various types of input data from sources external to the power plant 40 through an applicable network 75 such as, for example, a local area network (LAN), wide area network (WAN), Internet, a wireless network, etc. employing a suitable communication protocol. In particular, the power plant controller 46 may receive a global set point for power production from an external source, such as a SCADA, over the network 75 using an appropriate SCADA protocol.

The power plant controller 46 includes a human machine interface (HMI) 76 that is operatively connected to the processor 66 in a conventional manner. The HMI 76 may include output devices, such as alphanumeric displays, a touch screen, and other visual indicators, and input devices and controls, such as an alphanumeric keyboard, a pointing device, keypads, pushbuttons, control knobs, etc., capable of accepting commands or input from the operator and transmitting the entered input to the processor 66.

The power plant controller 46 includes a sensor interface 78 that allows the power plant controller 46 to communicate with the sensors 58, 60, 62, 64. The sensor interface 78 may be or may comprise one or more analog-to-digital converters configured to convert analog signals from the sensors 58, 60, 62, 64 into digital signals for use by the processor 66 of the power plant controller 46.

In an embodiment, the power plant controller 46 may also rely on one or more virtual or soft sensors represented by software in the form of an algorithm residing in the memory 68 and executing on the processor 66. Each soft sensor may be implemented by using one or more process models with error correction capabilities. The process models are used in each soft sensor to generate values of one or more soft variables, which are not directly measured, based on sensor readings originating from one or more of the physical sensors 58, 60, 62, 64. In the representative embodiment, each virtual sensor is configured to utilize the high frequency sensor readings acquired by one or sensors 58, 60, 62, 64 as inputs measurements to the algorithm implementing the soft sensor. The interactions between the sensor readings may be used by the soft sensor to calculate one or more soft variables that may be input into the control algorithm 72.

The control algorithm 72 executing on the power plant controller 46 solves an optimization problem in real-time to provide a predicted power reference, P_{WF}^{ref}, representing a decision variable for power production from the wind farm 42 and a predicted power reference, P_{ES}^{ref}, represents a decision variable for power production from the power plant 40 to optimize a given power plant objective. Inputs to the control algorithm 72 for these computations include the time-varying state information for the wind turbines 10a, 10b received from the at least one sensor 58 and the actual time-varying power, P_{WF}(t), output from the wind farm 42 that is measured by the at least one sensor 62, as well as other application-specific inputs and constraints as discussed hereinafter.

The power plant controller 46 dynamically issues the power reference, P_{WF}^{ref}, as a series of set points or commands to the wind turbine controllers 36, 38 of wind turbines 10a, 10b in the wind farm 42. The set points or commands contained in the power reference, P_{WF}^{ref}, may include a vector containing a series of future settings for active power and reactive power for the wind farm 42. The power reference, P_{WF}^{ref}, is implemented at the wind farm 42 by control signals communicated from the power plant controller 46 to the wind turbine controllers 36, 38. The control signals represent operational directives that are coordinated such that the individual wind turbines 10a, 10b of the wind farm 42 effectively act as a single power production unit.

The wind farm 42 responds to the power reference, P_{WF}^{ref}, communicated from the power plant controller 46 to the wind turbine controllers 36, 38 by adjusting the power generation or production from one or more of the individual wind turbines 10a, 10b in the wind farm 42. The response of the wind farm 42 to the power production commands is based upon the individual responses for each of the wind turbines 10a, 10b. The power production for the wind farm 42 is a composite of the power production from each of the individual wind turbines 10a, 10b.

The control algorithm executing on the power plant controller 46 computes the decision variable, P_{ES}^{ref}, as a power reference targeted as a predicted power production of the energy storage system 44. Inputs to the control algorithm 72 for this calculation include the time-varying state information for the energy storage system 44 received from the at least one sensor 58 and the actual time-varying power, P_{ES}(t), output from the energy storage system 44 that is measured by the at least one sensor 62, as well as other application-specific inputs and constrains as discussed hereinafter.

The power plant controller 46 dynamically issues the power reference, P_{ES}^{ref}, as a series of set points or commands to the energy storage controller 54. The set points or commands contained in the power reference, P_{ES}^{ref}, may include a vector containing a series of future settings for active power and reactive power for the energy storage system 44. The power reference, P_{ES}^{ref}, is implemented at the energy storage system 44 by control signals communicated from the power plant controller 46 to the energy storage controller 54.

In accordance with embodiments of the invention, the control algorithm 72 executes as a set of instructions on the processor(s) of the power plant controller 46 to compute the power reference, P_{WF}^{ref}, for the wind farm 42 and the power reference, P_{ES}^{ref}, for the energy storage device 50. At a given time t, the power plant controller 46 samples the state information for the wind farm 42 and the state information energy storage system 44. The control algorithm 72 executes a numerical algorithm to compute the optimal path of a control strategy for a relatively short time horizon, t+Δt, in the future. The online or real-time calculation investigates different paths for power production by the wind farm 42 and energy storage system 44 derived from the current sampled state information for the wind farm 42 and energy storage system 44 and defines a specific path as an optimal control strategy to optimize a given power plant objective until the future time, t+Δt. In one embodiment for which the control algorithm 72 is a model predictive control (MPC) algorithm, the numerical algorithm represents a dynamic model.

Although the control path may include a series of further adjustments to the wind farm 42 and the energy storage system 44 as steps of the control strategy, only the initial or first step of the optimal path for the control strategy is implemented. In response to the implementation of the first step, the state information for the wind farm 42 and energy storage system 44 is sampled again and the calculations of the power reference, P_{WF}^{ref}, for the wind farm 42 and the power reference, P_{ES}^{ref}, for the energy storage device 50 are repeated starting from the more recent state information received from the wind farm 42 and energy storage device 50. The calculations by the control algorithm 72 yield a new control and new predicted path as an updated control strategy, based upon the more recent state information, for the power production by the wind farm 42 and energy storage system 44.

The state information sampling and computations are repeated at subsequent control intervals. At each control interval, control algorithm 72 attempts to optimize the future behavior of the wind farm 42 and the energy storage system 44 by computing future control input adjustments as a sequence that will result in operation of the power plant 40 and honor all metrics or constraints input to the control algorithm 72. The prediction horizon for the power references P_{WF}^{ref}, P_{ES}^{ref} continuously shifted into the future for at any given future time, t.

In the computation, the control algorithm 72 decides how to optimally blend the control actions for the wind turbines 10a, 10b of the wind farm 42 and the energy storage system 44 of the wind farm 42 in the development of the control strategy. During the blending process, the control algorithm 72 considers during the calculation that multiple paths are available for the control profiles of the energy storage system 44 and the wind turbines 10a, 10b of the wind farm 42 to achieve the same power production from the power plant 40. The control algorithm 72 identifies the particular path, from among the multiple paths, defining power references P_{WF}^{ref}, P_{ES}^{ref} in a blend that optimizes one or more additional constraints or metrics, as well as one or more applications 80, that are folded as inputs into the calculations

In one embodiment, the metrics may include a property of the wind farm 42, such as the lifetime of the wind farm 42 or the operating expense of the wind farm 42, or a property of the energy storage system 44, such as the lifetime of the energy storage device 50 or the operating expense for the energy storage system 44. The control algorithm 72 may also consider metrics representing restrictions (maximum pitch rate for the blades 24, etc.) on controls for the wind turbines 10 in wind farm 42 and metrics representing restrictions (maximum energy storage capacity, maximum output power, etc.) on the energy storage device 50. Another example of a metric may be to maximize the revenue of the power plant 40 over a time period, such as a projected lifetime (e.g., a 20 year lifetime) of the power plant. Another example of a metric may be to minimize stress on critical wind turbine components, such as the gearbox 30, under the presence of rapid wind variations or after low-voltage-ride-through (LVRT) situations. The constraints or metrics considered by the control algorithm 72 to determine the optimum blend of power references P_{WF}^{ref}, P_{ES}^{ref} may also relate to one or more applications for the power plant 40.

A representative application for the power plant 40 may be Forecast Accuracy Improvement. The goal of this metric is to control the wind farm 42 and to charge and discharge the energy storage device 50 in the blend of power references P_{WF}^{ref}, P_{ES}^{ref} such that actual power production from the power plant 40 is closer to forecasted power production (and economic Penalties on the power plant 40 are thus lowered).

Another representative application for the power plant 40 may be to use the energy storage device 50 for Storing Curtailed Production. Grid capacity constraints may force the power production of the wind farm 42 below the wind potential; i.e., production is curtailed. The goal of this metric is to use the energy storage device 50 in the blend of power references P_{WF}^{ref}, P_{ES}^{ref} to at least partially store the curtailed production and release the store energy later when grid capacity allows and energy prices are convenient.

Another representative application for the power plant 40 may be energy storage for Production Shift. Hour-to-hour variation of energy spot-prices can be very large. The goal of this metric is to use the energy storage device 50 in the blend of power references P_{WF}^{ref}, P_{ES}^{ref} such that the energy storage device 50 stores the energy produced by the wind farm 42 when spot-prices are low and sells the stored energy when spot-prices are high (a.k.a. energy arbitrage).

Another representative application for the power plant 40 may be energy storage for Capacity Firming The capacity firming application commits to provide a particular power output from the power plant 40 for a specific period of time. The power level and time are committed for a day or so in advance of when the power is delivered. Because of harsh penalties for not providing the committed firm capacity, the status of the energy storage device 50 must be maintained to ensure the firm capacity can be provided even if there is no power production from the wind farm 42.

Applications can be combined with constraints and metrics to provide the optimal path characterized by the power references P_{WF}^{ref}, P_{ES}^{ref}. For example, the path may be selected to satisfy one or more of the applications 80, such as Storing Curtailed Production, and to also satisfy other metrics for the energy storage device 50 (e.g., the life consumed for the energy storage device 50 is below a given elapsed time threshold) and the wind farm 42 (e.g., the life consumed for the wind turbines 10a, 10b is below a given elapsed time threshold).

The adjustments to the power references P_{WF}^{ref}, P_{ES}^{ref} may be in real time. As used herein, real-time refers to adjustments to the power production of the power plant 40 occurring at a substantially short period and without substantial intentional delay after computation and communication of the power references P_{WF}^{ref}, P_{ES}^{ref}. The period may be an amount of time the adjustments to the optimal control strategy by the control algorithm 72. Some tolerable delays may occur as time lags for the power plant 40 to implement the power references P_{WF}^{ref}, P_{ES}^{ref} as reflected by the time-varying output powers P_{WF}(t), P_{ES}(t).

FIG. 5 shows a flowchart 100 illustrating a sequence of operations for the power plant controller 46 to optimize the operation and output of the power plant 40 consistent with embodiments of the invention. In particular, the power plant controller 46 receives state information regarding the wind farm 42 supplied from the at least one sensor 58 (block 102). The power plant controller 46 also receives state information regarding the energy storage system 44 supplied from the at least one sensor 60 (block 104). The state information is directed to the processor 66 as inputs to the control algorithm 72.

In block 106, power references are computed by the control algorithm 72 executing on the processor 66 of power plant controller 46. Specifically, the control algorithm 72 as computes the decision variable, P_{WF}^{ref}, as an optimal path used as the power reference for the future power production of the wind farm 42 and the control algorithm 72 computes the decision variable, P_{ES}^{ref}, as an optimal path used as the power reference for the future power production of the energy storage system 44. The control algorithm 72 uses the time-varying state information for the wind farm 42 and the time-varying state information for the energy storage system 44 at the current time, t, as inputs to optimize a given power plant objective. The computation with the control algorithm 72 also inputs one or more selected applications 80 for the power plant 40, as well as other constraints or metrics on the power plant 40 as discussed above, to optimize the given power plant objective. As discussed above, the control algorithm 72 may be a model predictive control algorithm in a representative embodiment.

In block 108, the power plant controller 46 dynamically issues the power reference, P_{WF}^{ref}, as a series of predicted set points or commands to the wind turbine controllers 36, 38 of wind turbines 10a, 10b in the wind farm 42. The power reference, P_{WF}^{ref}, sets the power production by the wind farm 42 as an optimal path of the coordinated control strategy for a relatively short time horizon, t+Δt, in the future.

In block 110, the power plant controller 46 dynamically issues the power reference, P_{ES}^{ref}, as a series of predicted set points or commands to the energy storage controller 54 of the energy storage system 44. The power reference, P_{ES}^{ref}, sets the power production or consumption by the energy storage system 44 as an optimal path of the coordinated control strategy for a relatively short time horizon, t+Δt, in the future.

In block 112, the power contributions from the wind farm 42 and energy storage system 44 are supplied to the point of common connection 65 to provide the power plant output. Only the initial or first step of the optimal path for the control strategy devised by the control algorithm 72 is implemented before the computation is iterated at another control interval with more recent state information for the wind farm 42 and energy storage system 44. Consequently, the sequence of operations in flowchart 100 then returns to block 102 for the power plant controller 46 to compute another set of power references P_{WF}^{ref}, P_{ES}^{ref} as an optimum predicted control path based upon the time-varying state information for the wind farm 42 and energy storage system 44 sampled at a future time, t+Δt.

As will be appreciated by one skilled in the art, the embodiments of the invention may also be embodied in a computer program product embodied in at least one computer readable storage medium having non-transitory computer readable program code embodied thereon. The computer readable storage medium may be an electronic, magnetic, optical, electromagnetic, infrared, or semiconductor system, apparatus, or device, or any suitable combination thereof, that can contain, or store a program for use by or in connection with an instruction execution system, apparatus, or device. Exemplary computer readable storage medium include, but are not limited to, a hard disk, a floppy disk, a random access memory, a read-only memory, an erasable programmable read-only memory, a flash memory, a portable compact disc read-only memory, an optical storage device, a magnetic storage device, or any suitable combination thereof. Computer program code containing instructions for directing a processor to function in a particular manner to carry out operations for the embodiments of the present invention may be written in one or more object oriented and procedural programming languages. The computer program code may supplied from the computer readable storage medium to the processor of any type of computer, such as the processor 66 of the power plant controller 46, to produce a machine with a processor that executes the instructions to implement the functions/acts of a computer implemented process for sensor data collection specified herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “composed of”, or variants thereof are used in either the detailed description or the claims, such terms are intended to be inclusive in a manner similar to the term “comprising.”

While the invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicant's general inventive concept.

What is claimed is:

1. A power plant for outputting power to a point of common connection with a power grid, the power plant comprising:
a wind farm including a plurality of wind turbines configured to generate and output a first portion of the power to the point of common connection;
an energy storage system including an energy storage device configured to be charged by the wind turbines, the energy storage device configured to output a second portion of the power to the point of common connection; and
a supervisory controller coupled in communication with the energy storage system and in communication with the wind farm, the supervisory controller configured to implement a control algorithm to dynamically compute a first power reference for the first portion of the power output by the wind farm and a second power reference for the second portion of the power output by the energy storage system.

2. The power plant of claim 1 wherein the energy storage device includes a rechargeable battery.

3. The power plant of claim 1 wherein the energy storage device includes a rechargeable battery, a flywheel, a capacitor bank, or any combination thereof.

4. The power plant of claim 1 wherein the control algorithm is a model predictive control algorithm that uses a numerical algorithm representing a dynamic model of the power plant.

5. The power plant of claim 1 further comprising:
at least one first sensor configured to provide sensor readings to the supervisory controller representing state information of the wind farm; and
at least one second sensor configured to provide sensor readings to the supervisory controller representing state information of the energy storage system;
wherein the supervisory controller causes the control algorithm to generate an optimal path for the first and second power references, the state information of the wind farm as a first input to the control algorithm, and the state information of the energy storage device as a second input to the control algorithm.

6. The system of claim 5 wherein the supervisory controller includes a soft sensor configured to compute the state information based upon the sensor readings from the at least one first sensor or configured to compute the state information based upon the sensor readings from the at least one second sensor.

7. The power plant of claim 1 wherein the supervisory controller causes the control algorithm to generate an optimal path for the first and second power references, and an input to the control algorithm is an application for the energy storage system at the power plant.

8. The power plant of claim 1 wherein the supervisory controller causes the control algorithm to generate an optimal path for the first and second power references, and an input to the control algorithm is at least one of a lifetime of the wind farm, an operating expense of the wind farm, a lifetime of the energy storage device, or an operating expense for the energy storage system.

9. The power plant of claim 1 wherein the supervisory controller causes the control algorithm to generate an optimal path for the first and second power references, and an input to the control algorithm is at least one of a restriction on one or more controls for the wind turbines in the wind farm or a restriction on the energy storage device.

10. The power plant of claim 1 wherein the supervisory controller causes the control algorithm to generate an optimal path for the first and second power references, and an input to the control algorithm is revenue from the power output by the power plant over a time period.

11. The power plant of claim 1 wherein the supervisory controller causes the control algorithm to generate an optimal path for the first and second power references in real time, and to communicate the optimal path to the energy storage system and to the wind farm in real time.

12. A computer-implemented method for controlling power output by a power plant to point of common connection with a power grid, the method comprising:
using a control algorithm to dynamically compute a first power reference for a first portion of the power output from a wind farm of the power plant and a second power reference for a second portion of the power output by an energy storage system of the power plant;
controlling the energy storage system to output the first portion of the power to the point of common connection based upon the first power reference; and
controlling the wind farm to output the second portion of the power to the point of common connection based upon the second power reference.

13. The computer-implemented method of claim 12 wherein the energy storage device includes a rechargeable battery.

14. The computer-implemented method of claim 12 wherein the energy storage device includes a rechargeable battery, a flywheel, a capacitor bank, or any combination thereof.

15. The computer-implemented method of claim 12 wherein the control algorithm is a model predictive control algorithm that uses a numerical algorithm representing a dynamic model of the power plant.

16. The computer-implemented method of claim 12 further comprising:
providing state information of the wind farm as a first input to the control algorithm;
providing state information of the energy storage system as a second input to the control algorithm; and
generating an optimal path for the first and second power references using the control algorithm.

17. The computer-implemented method of claim 12 further comprising:
providing an application for the energy storage system at the power plant as an input to the control algorithm; and
generating an optimal path for the first and second power references using the control algorithm.

18. The computer-implemented method of claim 12 further comprising:
providing at least one of a lifetime of the wind farm, an operating expense of the wind farm, a lifetime of the energy storage device, or an operating expense for the energy storage system to the control algorithm; and
generating an optimal path for the first and second power references using the control algorithm.

19. The computer-implemented method of claim 12 further comprising:
providing at least one of a restriction on controls for the wind turbines in the wind farm or a restrictions on the energy storage device to the control algorithm; and
generating an optimal path for the first and second power references using the control algorithm.

20. The computer-implemented method of claim 12 further comprising:
providing revenue of the power plant over a time period to the control algorithm; and
generating an optimal path for the first and second power references using the control algorithm.

21. The computer-implemented method of claim 12 wherein the supervisory controller causes the control algorithm to generate an optimal path for the first and second power references in real time, and to communicate the optimal path to the energy storage system and to the wind farm in real time.

22. A computer program product comprising:
a computer readable storage medium; and
program instructions for performing the method of claim 12,
wherein the program instructions are stored on the computer readable storage medium.
